(19) United States
(12) Patent Application Publication
(10) Pub. No.: US 2026/0218825 A1
(43) Pub. Date: Jul. 30, 2026

(54) BEADED HOSE FITTING QUICK CONNECTOR WITH AUDIBLE AND VISUAL SEAL VERIFICATION

(71) Applicant: Voss Automotive, Inc., Fort Wayne, IN (US)

(72) Inventors: Randon Ripley, Fort Wayne, IN (US); Jacob Hansel, New Haven, IN (US); Eric W. Maxwell, Fort Wayne, IN (US)

(73) Assignee: Voss Automotive, Inc., Fort Wayne, IN (US)

(21) Appl. No.: 19/460,460

(22) Filed: Jan. 27, 2026

Related U.S. Application Data
(60) Provisional application No. 63/750,933, filed on Jan. 29, 2025.

(51) Int. Cl. F16L 37/091

(52) U.S. Cl. CPC F16L 37/0915; F16L 2201/10

(57) ABSTRACT

A beaded hose fitting quick connector having audible and visual seal verification includes a main body defining a fluid passageway and configured for sealing engagement with a beaded hose fitting, an O-ring seal received on a ledge defined within the fluid passageway, an inner ring disposed within the main body and having a flexible tab biased to resiliently engage a beaded end, an intermediate ring disposed outwardly of the inner ring and having a verification pawl presenting a scannable code, and a grip ring disposed outwardly of the intermediate ring, the grip ring defining a window through which the scannable code is displayed when the connector is in a locked position.

### CROSS-REFERENCE TO RELATED APPLICATIONS

This application claims priority to U.S. Provisional Application No. 63/750,933, filed on January 29, 2025, which is incorporated herein by reference in its entirety.

### FIELD OF THE DISCLOSURE

This disclosure relates to quick-connect fluid couplings, and more particularly to quick-connect fluid couplings that are configured for coupling with a hose bead style fitting.

### BACKGROUND OF THE DISCLOSURE

Many customers have existing components in their system, such as pumps, valves, and radiators, that utilize a hose fitting with a beaded end. These beaded hose fittings are designed to be used with hoses that are intended to be retained by hose clamps. The beaded hose fittings on these components are not interchangeable and changing the fitting to a quick-connect style connection would require the customers to use a different component, requiring additional validation and potential cost increase. Current solutions are high cost, and the hose clamp options do not provide a verification option to ensure a leak tight seal.

Existing solutions have involved supplying an expensive bulk or formed hose, or using a hybrid system having a short hose on one end and a union that transitions from hose to tubing (e.g., nylon), which reduces cost slightly, but substantially increases complexity and compromises reliability.

### SUMMARY OF THE DISCLOSURE

The disclosed hose bead quick connector with audible and visual seal verification includes a main body defining a fluid passageway, and having a tube connector portion and a coupling portion for sealingly engaging a beaded hose fitting. An O-ring seal is received on a

ledge defined within the fluid passage at the coupling portion of the main body. An inner ring is disposed within the coupling portion of the main body and has at least one flexible tab biased to resiliently engage a hose bead. An intermediate ring is disposed radially outwardly of the inner ring and has at least one verification pawl projecting radially outwardly, and presenting a scannable code (e.g., a QR code) on an outer surface of the intermediate ring. A grip ring is disposed radially outwardly of the intermediate ring. The grip ring defines a window through which the scannable code on the intermediate ring is displayable when the connector is in a locked position. The grip ring also has teeth engageable with the verification pawl to generate an audible signal (e.g., a clicking sound) indicating that the connector is in the locked position.

### BRIEF DESCRIPTION OF THE DRAWINGS

FIG. 1 is an elevational view of a quick connector in accordance with this disclosure used to provide a fluid connection between a beaded hose fitting and a plastic tube (e.g., polyamide tube).

FIG. 2 is a perspective view of the disclosed quick connector fully assembled.

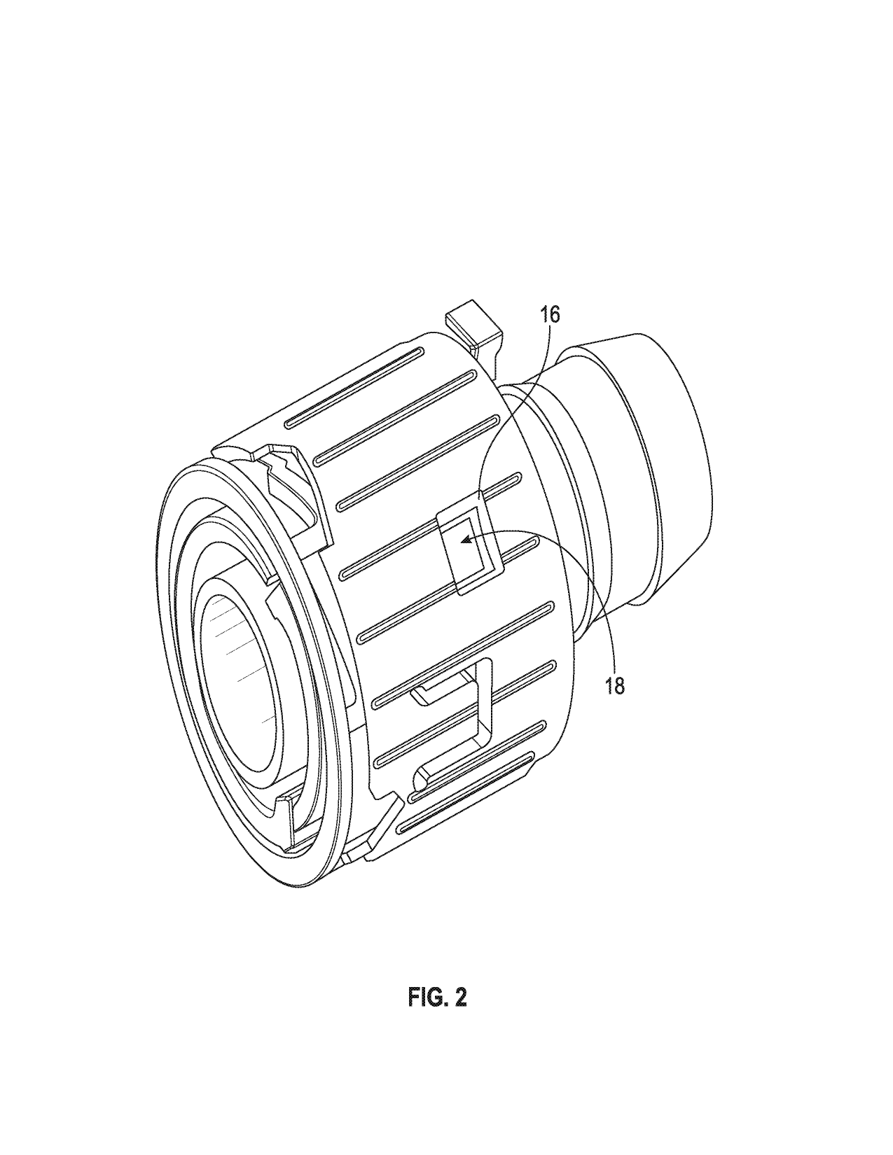

FIG. 3 is a perspective view of the main body of the disclosed quick connector.

FIG. 4 is a perspective view of the main body with portions broken away to illustrate features of the inner wall of the main body.

FIG. 5 is a perspective view of the intermediate ring.

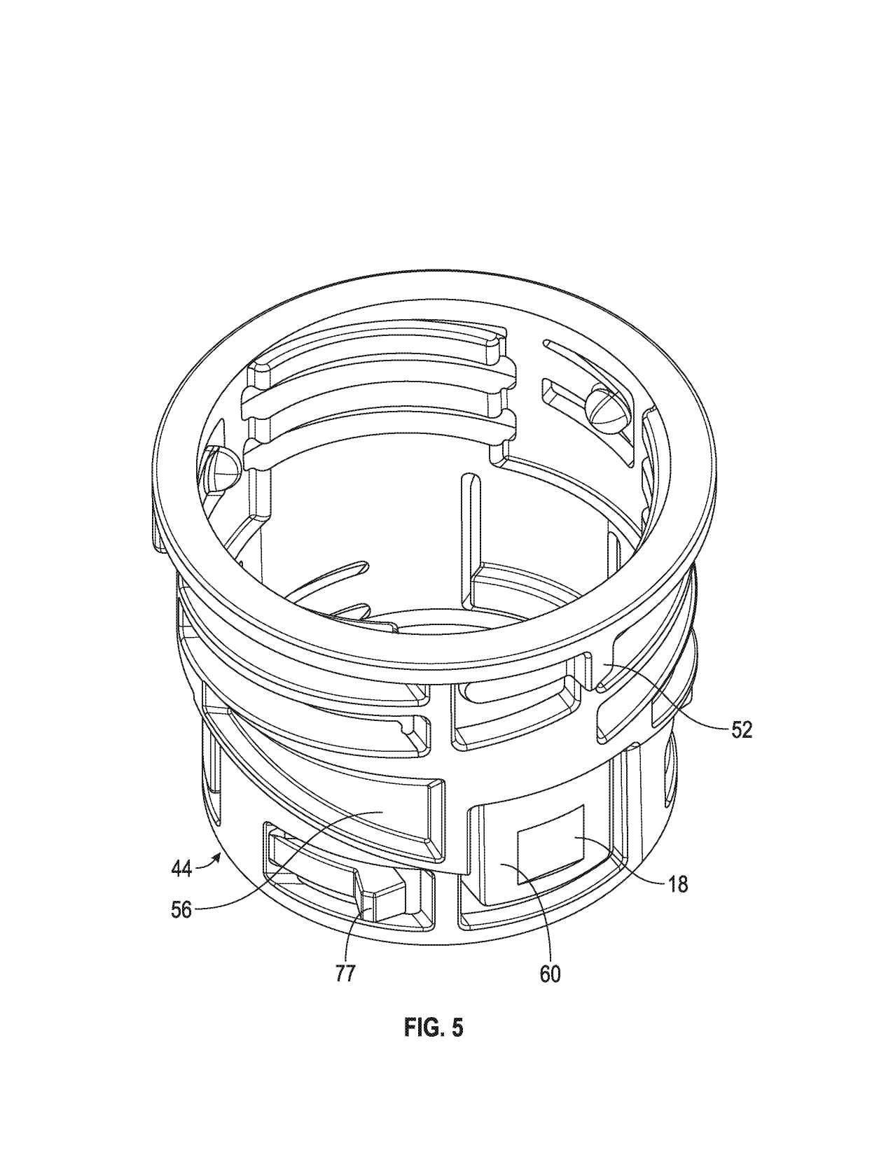

FIG. 6 is a perspective view of the intermediate ring with portions broken away to illustrate features of the inner wall of the intermediate ring.

FIG. 7 is a perspective view of the inner ring.

FIG. 8 is a perspective view of the inner ring with portions broken away to illustrate features of the inner wall of the inner ring.

FIG. 9 is a perspective view of the grip ring.

FIG. 10 is a perspective view of the grip ring with portions broken away to illustrate features of the inner wall of the grip ring.

FIG. 11 is a perspective view of the main body with an O-ring seal disposed on a ledge defined in the fluid passageway of the main body.

FIG. 12 is a cross-sectional view illustrating engagement between the disclosed quick connector and a beaded fitting.

### DETAILED DESCRIPTION

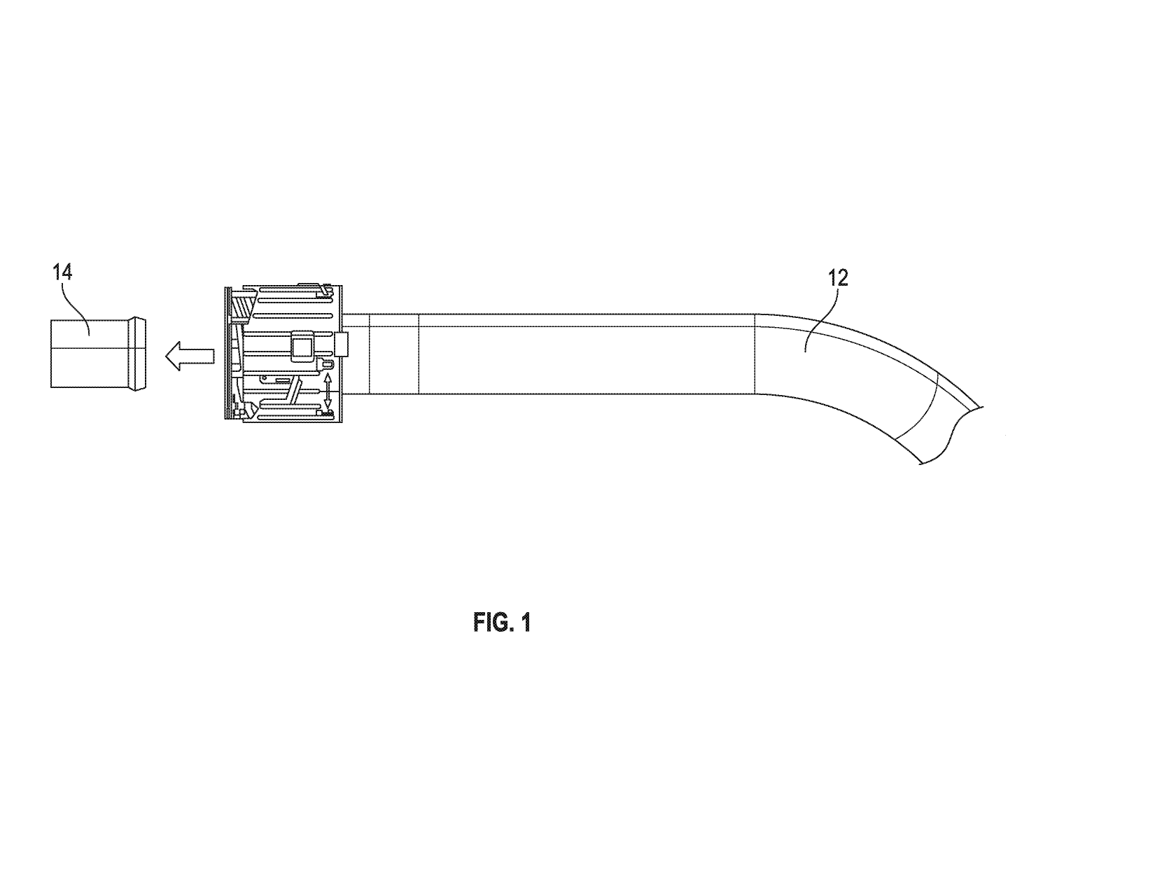

Shown in FIG. 1 is a quick connector 10 used for providing a fluid coupling between a tube 12 and a beaded fitting 14. Quick connector 10 has a window 16 for displaying a scannable code 18 (visual verification) indicating that the connector is in a locked configuration to prevent leakage of fluid.

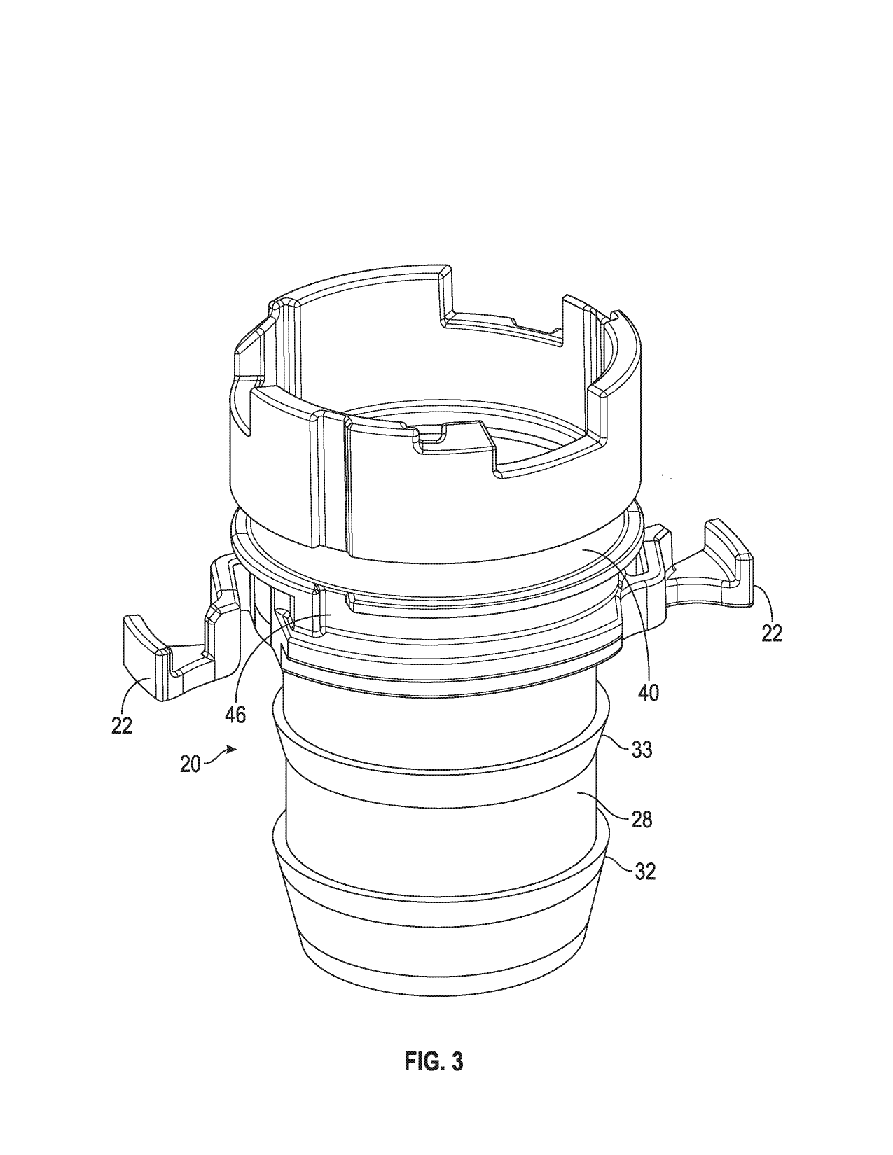

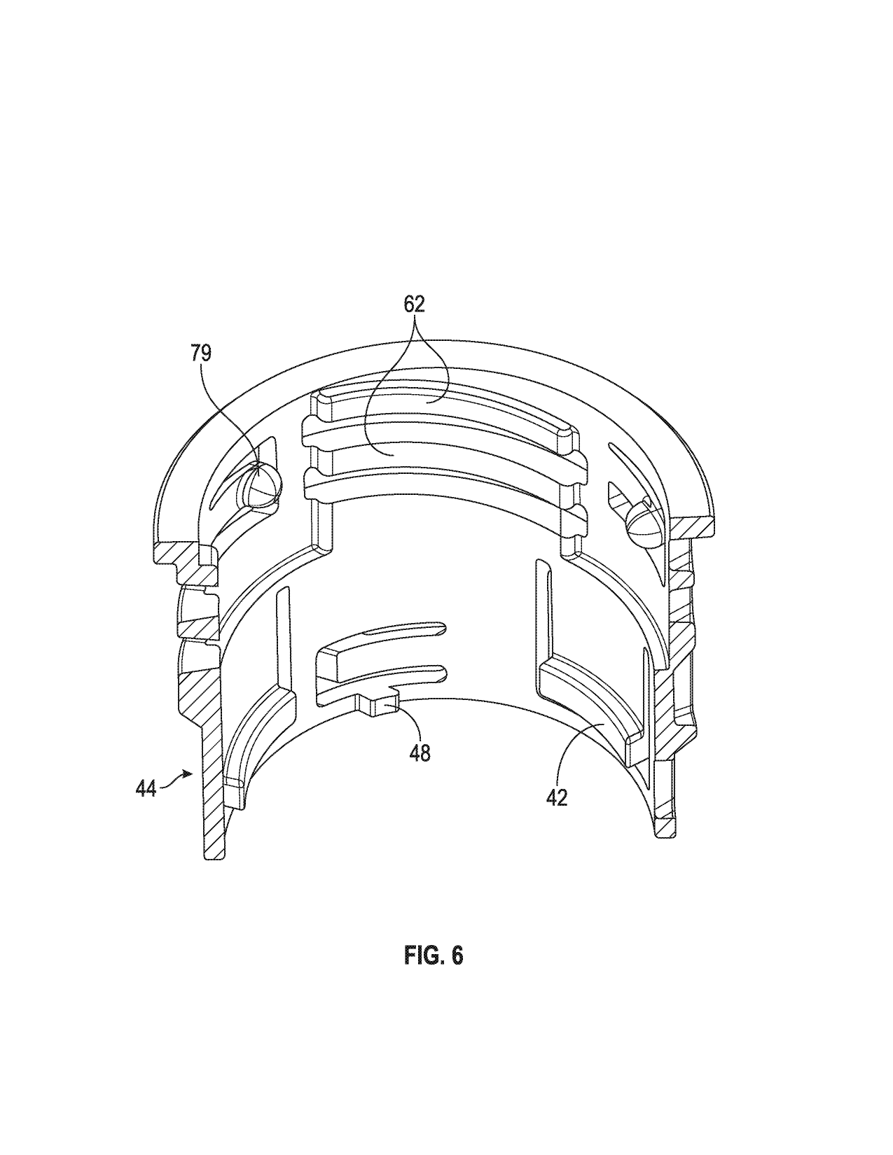

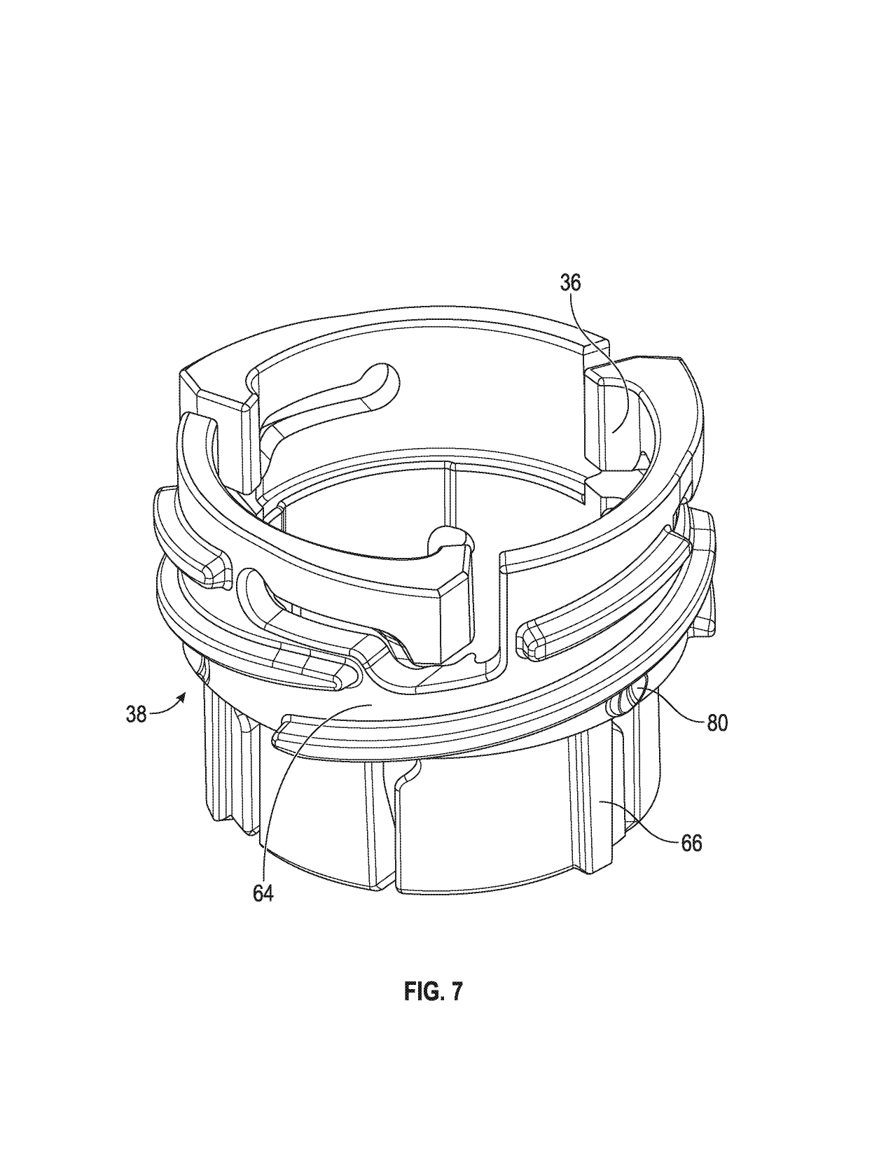

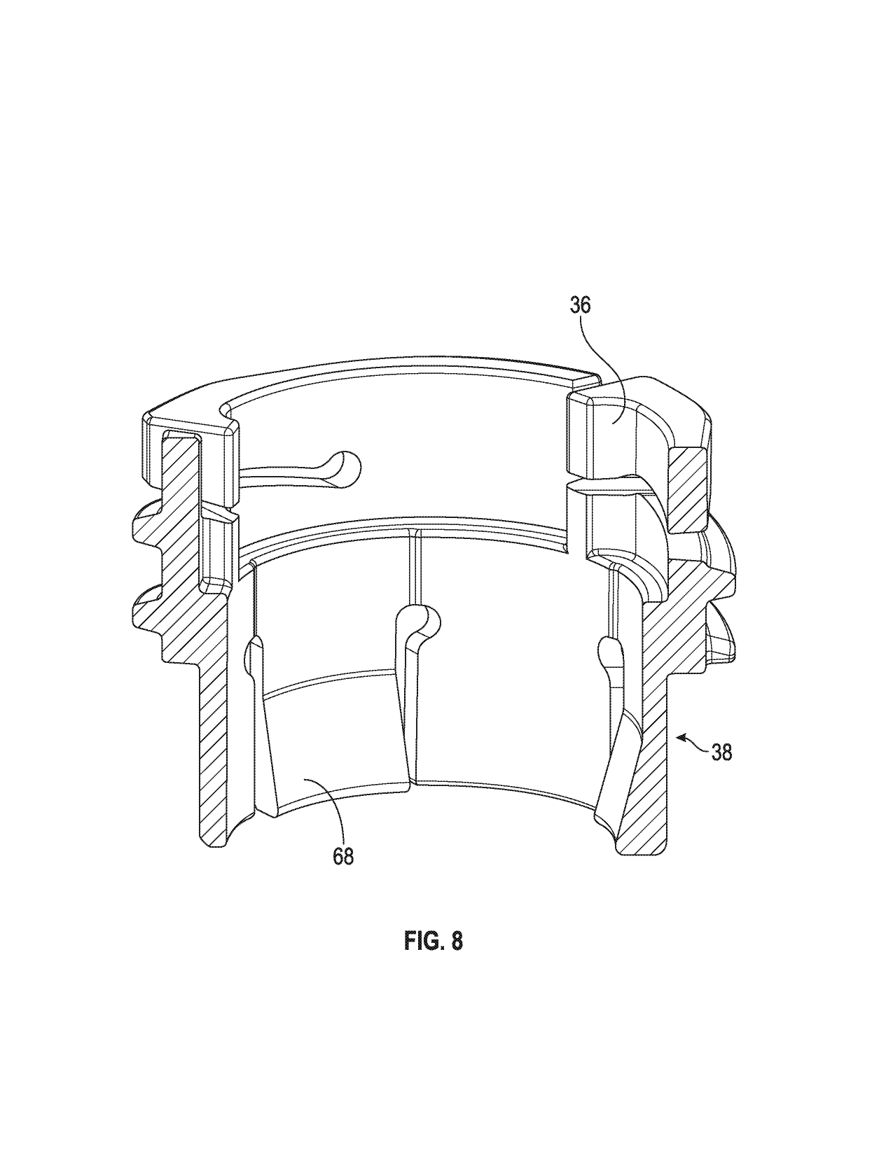

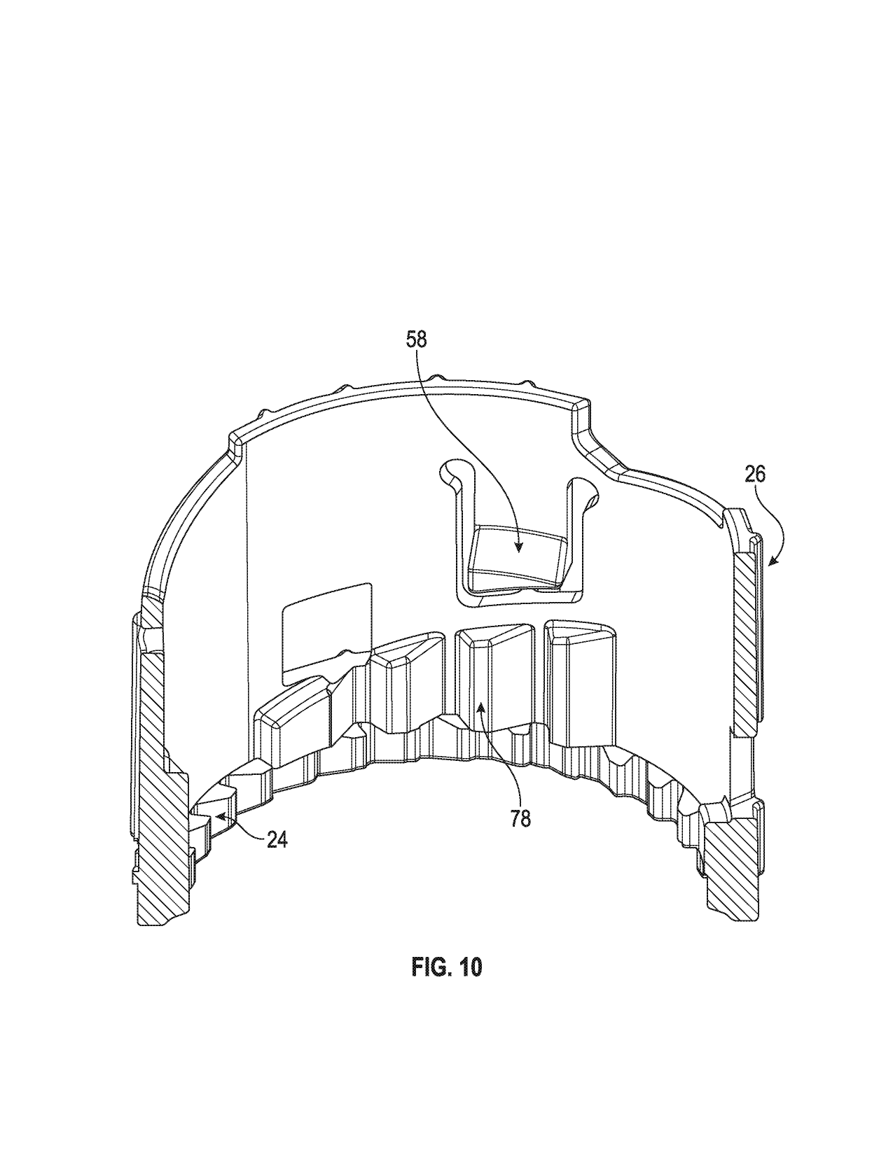

The main body 20 of the quick connector 10 is shown in FIG. 3. Main body 20 includes one or more pawls 22 (e.g., two that are 180 degrees apart) that are engageable with teeth 24 (FIG. 10) of the grip (or outer) ring 26 to provide a secondary lock. Main body 20 includes a connector portion 28 that is generally axially disposed on one side (the lower side in FIG. 3) of the pawl 22 for connecting with a tube 12, and a coupling portion 30 that is generally axially disposed on the other side (the upper side in FIG. 3) of the pawl 22. Connector portion 28 has barbs 32, 33 that allow a tube 12 to be relatively easily slid over the connector portion but which resist removal of the tube from the connector portion. Such connectors are sometimes referred to as fir tree connectors or Christmas tree connectors. Alternatively, connector portion 28 can be configured to allow tube 12 to be welded to main body 20 of connector 10, such as by using a laser welding or spin welding technique. In such case, connector portion 28 can have a cylindrical shape without barbs. Main body 20 has a window opening 34 defined at an edge of the open end of coupling portion 30 for receiving a flexible tab 68 on inner ring 38 (FIGS. 7 and 8). Tab 68 is relaxed in window 34 while connector 10 is in an unlocked state and slides under window 34 and locks onto the beaded fitting 14 when the connector is in the locked state. A first slot 40 extends at least partially along the outer circumferential surface of main body 20 for engagement with tabs 42 (FIG. 6) projecting from an inner wall of intermediate ring 44. Tabs 42 are configured to interlock with slot 40. A second slot 46 extends at least partially along the outer circumferential surface of main body 20 for engagement with boss 48 projecting from the inner wall of

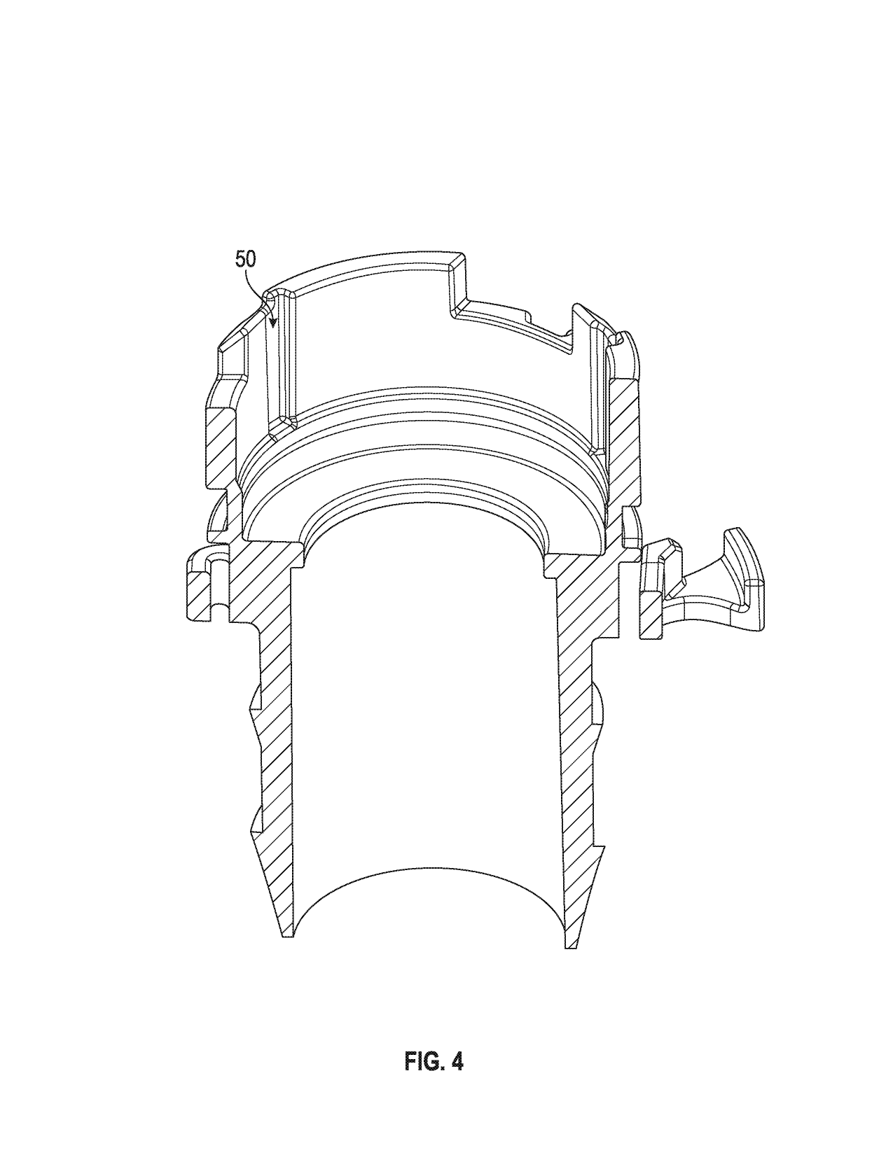

intermediate ring 44 to prevent disassembly of the inner ring 38 from intermediate ring 44 during unlocking. Boss 48 and the end of second slot 46 are both tapered such that the boss wedges under the end of the second slot to prevent the boss from riding up over the end of the second slot allowing the disassembly of the inner ring. In the illustrated embodiment, two bosses 48 are provided 180 degrees apart. A longitudinal slot 50 on the inner wall of main body 20 extends parallel with the flow or axial direction. Slot 50 guides movement along the flow axis. In the illustrated embodiment, three slots 50 are provided 120 degrees apart (see FIG. 4).

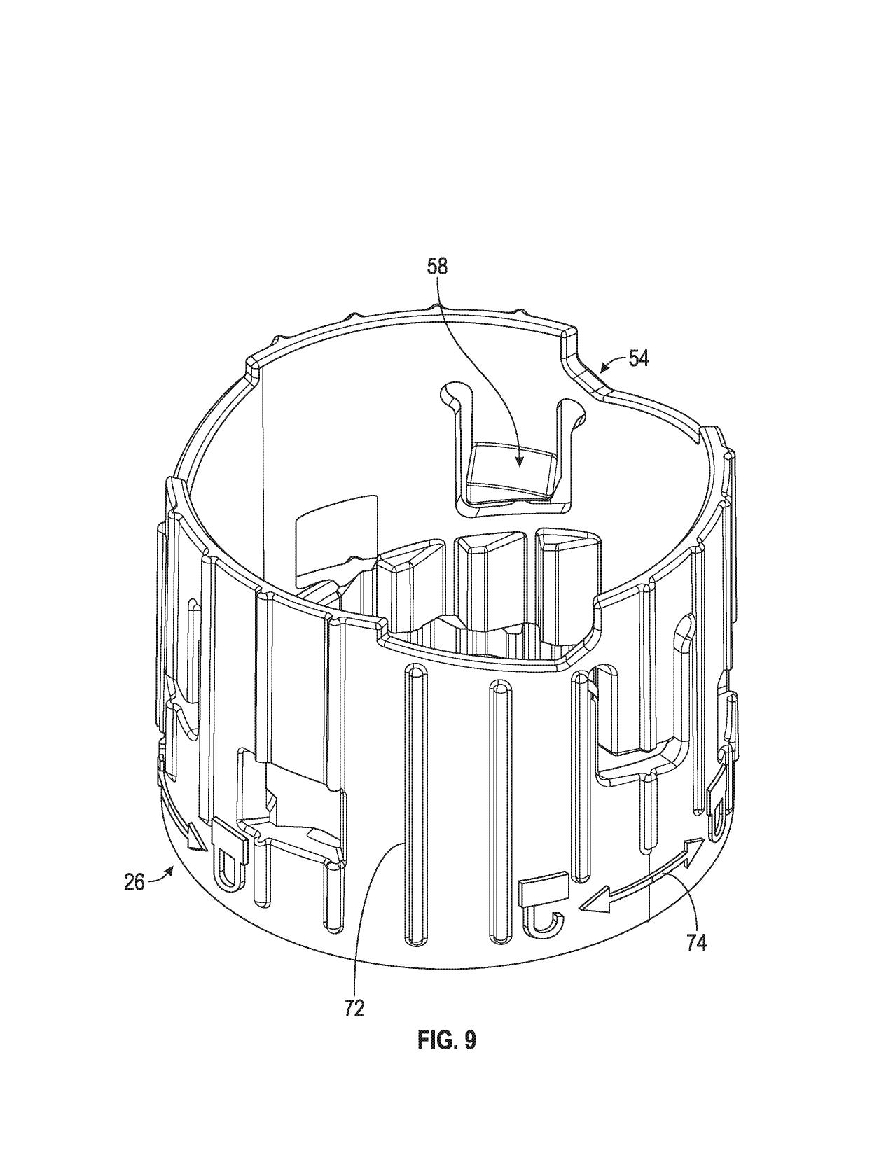

Intermediate ring 44 includes a boss 52 configured to engage an angled cutout 54 (FIG. 9) at the coupling end of grip ring 26. Engagement of boss 52 with cutout 54 facilitates axial movement of grip ring 26 during locking of connector 10. In the illustrated embodiment, three bosses 52 are disposed 120 degrees apart. A triangular slot 56 is provided on an outer wall of intermediate ring 44 to facilitate engagement with a flexible tab 58 (FIGS. 9 and 10) projecting radially inwardly from an inner wall of grip ring 26 to induce axial movement of grip ring 26 during unlocking of connector 10. In the illustrated embodiment, three triangular slots 56 are provided 120 degrees apart around the circumference of intermediate ring 44. Scannable code 18 (e.g., QR code) can be provided on a flexible tab 60. In the illustrated embodiment, three QR codes 18 are provided, each on a flexible tab 60 that are positioned 120 degrees apart. Intermediate ring 44 is provided with threaded mechanisms 62 that are threadingly engageable with threads 64 (FIG. 7) provided on outer wall of inner ring 38 for translating rotational movement of intermediate ring 44 into axial movement of inner ring 38. In the illustrated embodiment, three sets of threaded mechanisms 62 are provided with each set 120 degrees apart. The intermediate ring includes one or more flexible pawls 77 (e.g., three that are 120 degrees apart) that are engageable with teeth 78 (FIG. 10) of the grip (or outer) ring 26 that keep the grip ring from rotating about the center axis of the intermediate ring until a certain amount of torque is achieved. The intermediate ring includes one or more flexible pawls 79 (e.g., three that are 120 degrees apart) that are engageable with a recess 80 (FIG. 7) that keeps the intermediate ring in its initial, unlocked position until a specific amount of axial torque is applied.

Inner ring 38 includes a boss 66 that extends longitudinally along an outer wall of inner ring 38 for locating inner ring 38 into main body 20 and guiding inner ring 38 along the flow axis. In the illustrated embodiment, there are three bosses 66 separated by 120 degrees. A flexible

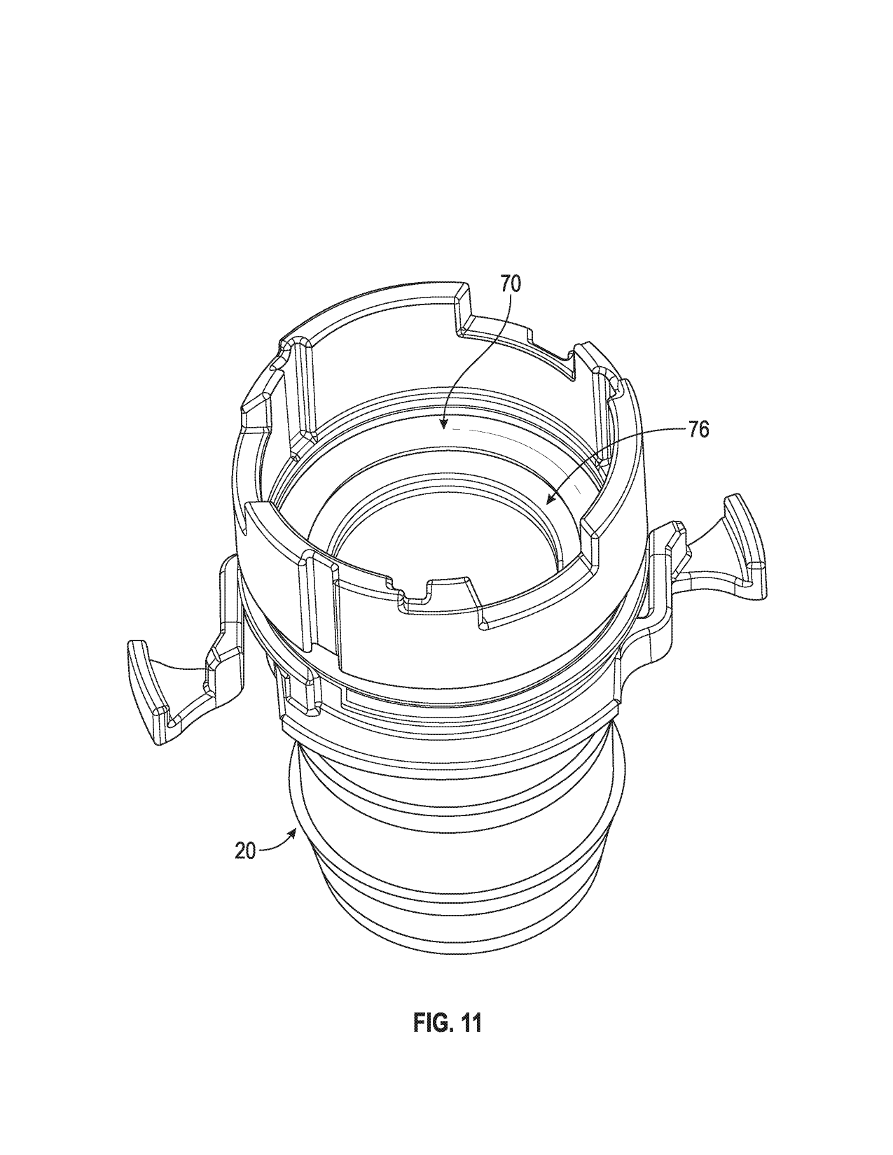

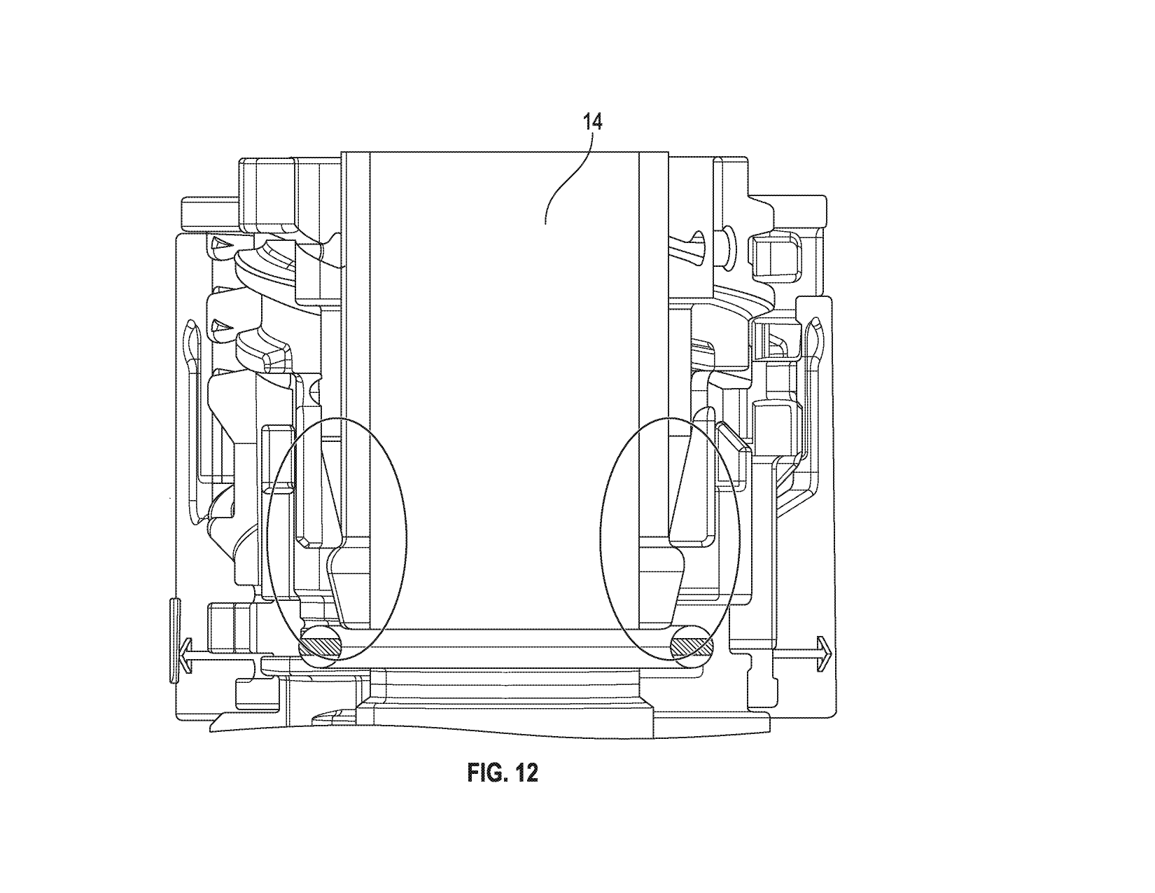

tab 68 extends inwardly from inner wall of inner ring 38 (see FIG. 8). Tab 68 locks behind the beaded end and draws the beaded hose fitting into O-ring 70 (FIG. 11), as is shown in FIG. 12. A flexible tab 36 extends inwardly from inner wall of inner ring 38 (see FIG. 8). Tab 36 flexes inwardly contacting the fitting in the locked position which centers the fitting inside the connector. In the illustrated embodiment, there are three tabs 36 separated by 120 degrees, and three tabs 68 separated by 120 degrees.

Grip ring 26 can include bumps 72, knobs, knurls or other grip-enhancing features on its outer surface. An embossment 74 can be provided on the outer surface of grip ring 26 to indicate the direction of rotation for locking and unlocking connector 20.

As shown in FIG. 11, O-ring 70 (e.g., EPDM or other elastomeric rubber) rests on a ledge 76 that extends circumferentially along the inner wall of main body 20.

FIG. 12 shows full locking engagement between quick connector 10 and beaded fitting 14.

The above description is intended to be illustrative, not restrictive. The scope of the invention should be determined with reference to the appended claims along with the full scope of equivalents. It is anticipated and intended that future developments will occur in the art, and that the disclosed devices, kits and methods will be incorporated into such future embodiments.

1. A beaded hose fitting quick connector with audible and visual seal verification, comprising: a main body defining a fluid passageway and having a barbed tube connector portion and a coupling portion for sealingly engaging a beaded hose fitting; an O-ring seal received on a ledge defined within the fluid passage at the coupling portion of the main body; an inner ring disposed within the coupling portion of the main body and having at least one flexible tab biased to resiliently engage a beaded end; an intermediate ring disposed radially outwardly of the inner ring and having at least one verification pawl projecting radially outwardly, and presenting a scannable code on an outer surface of the intermediate ring; and a grip ring disposed radially outwardly of the intermediate ring, the grip ring defining a window through which the scannable code on the intermediate ring is displayable when the connector is in a locked position, and having teeth engageable with the verification pawl to generate an audible signal indicating that the connector is in the locked position.

2. The beaded hose fitting quick connector of claim 1, wherein the grip ring has teeth and wherein the main body has at least one pawl that is configured to engage the teeth of the grip ring.

3. The beaded hose fitting quick connector of claim 1, wherein the main body has a defined window opening for receiving a flexible tab projecting radially inwards from inner wall of the inner ring, the flexible tab being released in the window when the connector is in an unlocked state, and in a stressed (locked) condition when slid underneath the window with the connector in a locked state.

4. The beaded hose fitting quick connector of claim 1, wherein the main body defines a first circumferential slot for receiving a flexible tab projecting from the intermediate ring to interlock the main body and the intermediate ring.

5. The beaded hose fitting quick connector of claim 1, wherein the main body has a second circumferential slot for receiving a boss projection from the intermediate ring to prevent disassembly of inner ring from intermediate ring during unlocking.

6. The beaded hose fitting quick connector of claim 1, wherein the main body defines a fir tree for connecting to tubing.

7. The beaded hose fitting quick connector of claim 1, wherein the main body has a cylindrical shape to facilitate welding of a tube to the connector.

8. The beaded hose fitting quick connector of claim 1, wherein the main body has a longitudinal slot on its wall for locating the boss on the inner ring and guiding movement of the inner ring along the flow axis.

9. The beaded hose fitting quick connector of claim 1, wherein the intermediate ring has a boss configured to engage a cutout on the grip ring to guide axial movement of the intermediate ring during locking of the connector.

10. The beaded hose fitting quick connector of claim 1, wherein the intermediate ring defines a triangular slot for engagement with a flexible tab on the grip ring to guide axial movement of the intermediate ring during unlocking of the connector.

11. The beaded hose fitting quick connector of claim 1, wherein the intermediate ring has at least one pawl configured to engage teeth on the grip ring.

12. The beaded hose fitting quick connector of claim 1, wherein the intermediate ring has at least one scannable code displayed on an outer surface.

13. The beaded hose fitting quick connector of claim 1, wherein the inner ring has an outer threaded mechanism engageable with the inner threaded mechanism of the intermediate ring for translating rotational movement to axial movement.

14. The beaded hose fitting quick connector of claim 1, wherein the intermediate ring has an inner threaded mechanism.

15. The beaded hose fitting quick connector of claim 1, wherein the intermediate ring has at least one boss configured to interact with a slot in the main body to prevent disassembly of inner ring from intermediate ring.

16. The beaded hose fitting quick connector of claim 1, wherein the boss and the slot are both tapered to cause the boss to be wedged under an end of the slot to prevent the boss from riding over the end of the slot.

17. The beaded hose fitting quick connector of claim 1, wherein the inner ring includes an outer longitudinal boss configured to engage an inner longitudinal recess of the main body to locate the inner ring into the main body and guide movement along the flow axis.

18. The beaded hose fitting quick connector of claim 1, wherein the inner ring defines at least one inwardly projecting flexible tab configured to lock behind a beaded end and draw the beaded hose fitting into the O-ring.

19. The beaded hose fitting quick connector of claim 1, wherein the grip ring defines at least one window for displaying the scannable code on the intermediate ring when the connector is in the locked state.

20. The beaded hose fitting quick connector of claim 1, wherein the grip ring defines an angled cutout to induce axial movement of the grip ring during locking of the connector.

21. The beaded hose fitting quick connector of claim 1, wherein an outer surface of the grip ring has a grip-enhancing feature.

22. The beaded hose fitting quick connector of claim 1, wherein the grip ring has at least one inwardly projecting flexible tab configured to induce axial movement of the grip ring during rotation of the grip ring.

23. The beaded hose fitting quick connector of claim 1, wherein an inner surface of the grip ring has primary teeth for engaging with at least one pawl on the intermediate ring during locking and unlocking of the connector.

24. The beaded hose fitting quick connector of claim 1, wherein an inner surface of the grip ring has secondary teeth for engaging with at least one pawl on the main body during locking and unlocking of the connector.

25. The beaded hose fitting quick connector of claim 1, wherein the intermediate ring has at least one inward facing pawl that engages with a recess on the inner ring to keep the intermediate ring in its initial position until a specific amount of axial torque is applied.
